(19) United States
(12) Patent Application Publication
(10) Pub. No.: US 2026/0261205 A1
(43) Pub. Date: Sep. 3, 2026

(54) SAMPLING BASED REGULATORS AND METHODS

(71) Applicant: Micron Technology, Inc., Boise, ID (US)

(72) Inventors: Akashdip Das, Kolkata (IN); Alimi Rakesh Kumar, Jagityal District (IN); Leela Madhav Lakkimsetti, Bengaluru (IN)

(21) Appl. No.: 19/542,996

(22) Filed: Feb. 18, 2026

Related U.S. Application Data
(60) Provisional application No. 63/765,952, filed on Mar. 3, 2025.

(51) Int. Cl. H02M 3/156; H02M 1/00

(52) U.S. Cl. CPC H02M 3/156; H02M 1/0009; H02M 1/0025

(57) ABSTRACT

Apparatuses and methods for voltage sampling in regulators are described. In particular, reference voltages and values may be sampled and maintained consistently across mode transitions between continuous conduction mode (CCM) and discontinuous conduction mode (DCM) in a regulator. This can reduce voltage undershoot or overshoot and may provide faster recovery times during transitions.

### PRIORITY INFORMATION

This application claims the benefit of U.S. Provisional Application No. 63/765,952, filed on Mar. 3, 2025, the contents of which are incorporated herein by reference.

### TECHNICAL FIELD

The present disclosure relates generally to electronic apparatuses and methods, and more particularly, to apparatuses, systems, and methods related to sampling based regulators.

### BACKGROUND

Voltage regulators play essential roles in supplying power to subsystems with distinct voltage and current needs. Linear regulators offer simplicity and low noise, while switching regulators, such as buck, boost, and buck-boost converters, achieve high efficiency for variable loads. For example, power management integrated circuits (PMICs) often integrate multiple voltage regulators and other functions, reducing board space and complexity while ensuring precise coordination across power rails in devices like smartphones, laptops, and embedded systems.

### BRIEF DESCRIPTION OF THE DRAWINGS

FIG. 1 illustrates an example electronic system that includes a voltage regulation component in accordance with some embodiments of the present disclosure.

FIG. 2 illustrates a switching voltage regulator having reverse voltage indication (RVI) circuit and a compensation circuit in accordance with some embodiments of the present disclosure.

FIG. 3 illustrates graphs showing states of various signals during a discontinuous conduction mode (DCM) in accordance with some embodiments of the present disclosure.

FIG. 4 illustrates graphs showing states of various signals during a continuous conduction mode (CCM) in accordance with some embodiments of the present disclosure.

FIG. 5 illustrates graphs showing states of various signals during transition from a DCM to a CCM in accordance with some embodiments of the present disclosure.

FIG. 6 illustrates graphs showing states of various signals during transition from a CCM to a DCM in accordance with some embodiments of the present disclosure.

FIG. 7 is a flow diagram corresponding to a method for operating a voltage regulator having a RVI circuit and a compensation circuit in accordance with some embodiments of the present disclosure.

### DETAILED DESCRIPTION

Systems, apparatuses, and methods related to voltage sampling in regulators are described. Switching voltage regulators may employ a V² control mechanism, which may include two closed-loop control systems for regulating output voltage. The first closed loop may feature an error amplifier that adjusts the output voltage (Vout) by minimizing the error between the output and an internal reference voltage (VREF). This loop, however, can be characterized by a slow response to transients, which causes delays in achieving stable output when sudden changes in load or input conditions occur. To mitigate these issues, a second, fast-response loop is often introduced to handle fast transients affecting Vout. This loop may address changes more quickly but is often insufficient in handling all operational states efficiently, especially in dynamic load conditions.

In voltage regulators utilizing Constant On-Time (COT) step-down control, emulated inductor current injection may be also implemented to stabilize the loop. However, challenges can arise from the inherent design of the error amplifier in these systems. Specifically, the error amplifier output does not react instantly to load changes, as it operates within the slower loop. This lag in response can also be complicated by the behavior of the emulated inductor current, which, although faster, does not fully compensate for the delayed error amplifier response. Consequently, the recovery time for Vout in DC-DC converters tends to be longer than desired, particularly in scenarios where the error amplifier output is dependent on load conditions.

Furthermore, in systems with emulated inductor current compensation, there is often a discrepancy in the steady-state output of the error amplifier when operating between Discontinuous Conduction Mode (DCM) and Continuous Conduction Mode (CCM). Typically, the error amplifier output can be higher in DCM than in CCM, which introduces additional delays during transitions between these modes. This mode transition, from DCM to CCM and back to DCM, causes further transient in the output voltage, requiring longer periods for Vout to settle back to the correct regulation voltage. These mode transitions between DCM to CCM and vice versa present challenges in maintaining constant voltage across a wide range of load conditions, and current designs fail to ensure that the error amplifier output remains independent of load variations and mode transitions.

Aspects of the present disclosure address the above and other challenges by sampling and maintaining various reference values, such as ramp voltages, which may be affected by load variations, substantially constant over mode transitions (e.g., from a DCM to a CCM, and vice versa). With these substantially constant reference values, the error amplifier is less influenced by changes that would typically occur during transitions, thereby making the error amplifier output “independent” of load conditions.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. It is to be understood that data can be transferred, read, transmitted, received, or exchanged by electronic signals (e.g., current, voltage, etc.).

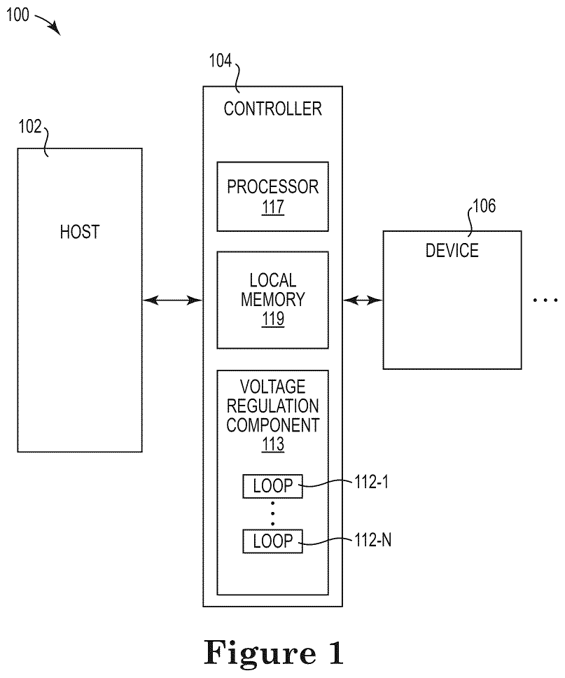

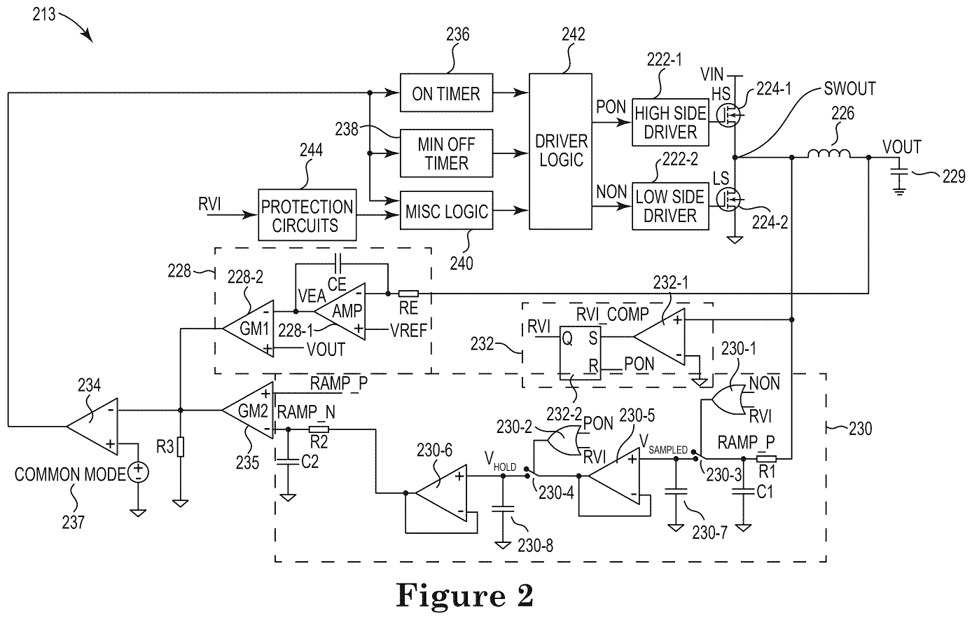

The figures herein follow a numbering convention in which the first digit or digits correspond to the drawing figure number and the remaining digits identify an element or component in the drawing. Similar elements or components between different figures may be identified by the use of similar digits. For example, 113 may reference element “13” in FIG. 1, and a similar element may be referenced as 213 in FIG. 2. Analogous elements within a Figure may be referenced with a hyphen and extra numeral or letter. See, for example, elements 228-1, 228-2 in FIG. 2. Such analogous elements may be generally referenced without the hyphen and extra numeral or letter. For example, elements 228-1, 228-2 may be collectively referenced as elements 228. As used herein, the designators “N”, particularly with respect to reference numerals in the drawings, indicate that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 illustrates an example electronic system 100 that includes a host 102, a controller 104, and a device 106 in accordance with various embodiments of the present disclosure. While the electronic system 100 can be considered as an apparatus, embodiments are not so limited. For example, the host 102, the controller 104, and the device 106 can each separately be considered as an apparatus.

The electronic system 100 can be, or can be part of, for example, a desktop computer, laptop computer, televisions, home theater system, gaming console, digital camera, network router and/or switch, printer, scanner, medical device, GPS navigation device, home device (e.g., thermostat, doorbell camera, security camera, smart lock, etc.), wearable device, industrial control system (e.g., automated industrial and/or control device) mobile computing device, a vehicle (e.g., airplane, drone, train, automobile, or other conveyance), Internet of Things (IoT) enabled device, embedded computer (e.g., one included in a vehicle, industrial equipment, or a networked commercial device), system-on-chip (SoC), chipset (e.g., a collection of integrated circuits), tile, Field-Programmable Gate Array (FPGA) structure (e.g., segmented FPGA structure), or other such device.

The electronic system 100 can be, or can include, a computing fabric. As used herein, the term “computing fabric” generally refers to a conveying, multiplexing, network, computing, or communication topology in which components pass data to each other through interconnecting switches, hubs, routers, multiplexers, buses, transmission lines and rings, cables, optical couplers and fibers, electromagnetic devices, or various other means. For example, a “computing fabric” can include various components (e.g., interconnects, crossbars, networks on chip, token rings, etc.) within a computing, memory, data storage and/or processing, network and/or telecommunication, artificial intelligence, control and/or telemetry, digital entertainment and/or other system, that facilitates in-chip and/or inter-chip communication.

The electronic system 100 includes a host 102. The host 102 can include a processor chipset and a software stack executed by the processor chipset. For example, the host 102 can be, or can include, a central processing unit (CPU) or a CPU complex that can be configured to execute an operating system.

The host 102 can be coupled to the controller 104 via a physical and/or logical host interface that operates based on various communication protocols and to provide control, address, data, and other signals to the controller 104 (e.g., to further cause the controller 104 to control the device 106). Examples of the interface between the host 102 and the controller 104 can include, but not limited to, a bus interface (e.g., a serial advanced technology attachment (SATA) interface, a Serial Attached SCSI (SAS) interface, a Serial Attached SCSI (SAS) interface, a Small Computer System Interface (SCSI), a peripheral component interconnect express (PCIe) interface, ISA, etc.), a memory interface (e.g., a double data rate (DDR) interface, a dual in-line memory module (DIMM) interface, an Open NAND Flash Interface (ONFI) interface, an NVM Express (NVMe) interface), a Fibre Channel, an UART interface, an I2C interface, a Serial Peripheral Interface (SPI), an Universal Serial Bus (USB) interface, an ethernet interface, a general-purpose input/output (GIPO) interface, a custom interface, etc.

The controller 104 is communicatively coupled to one or more electronic devices 116 such that signaling can be exchanged therebetween. Non-limiting examples of the devices 106 can include microcontrollers, microprocessors, digital logic circuits, analog circuits, light emitting diodes (LEDs), displays, sensors, motors, actuators, audio amplifiers, radio frequency (RF) circuits, test and measurement instruments (e.g., oscilloscopes, multimeters, etc.), automotive electronics, medical devices, telecommunication equipment, memory devices (e.g., volatile and/or non-volatile memory devices), graphics processing units, processors/co-processors, logic blocks, intellectual property (IP) cores, etc. As used herein, a “core” or “IP core” generally refers to one or more blocks of data and/or logic that form constituent components of an application-specific integrated circuit or field-programmable gate array. The circuit portion areas can be designed, built, and/or otherwise configured to perform specific tasks and/or functions within the systems described herein.

As shown in FIG. 1, the controller 104 can include a processing device (e.g., processor 117) that can execute instructions stored in a local memory 119 to perform various operations described herein. The controller 104 can include various special purpose circuitry in the form of an ASIC, FPGA, state machine, and/or other logic circuitry that can perform operations described herein. As an example, the controller 104 can be a memory controller.

In various embodiments, one or more constituent components (e.g., host 102, controller 104, device 106, etc.) of system 100 can be part of a SoC. In one example, a device 106 itself can correspond to an SoC, while the host 102 and the controller 104 are considered “external” to the SoC. In another example, the host 102 or the controller 104, or both, can be considered as a part of an SoC along with the device 106 being internal or external to the SoC.

In some embodiments, a device 104 can be a storage device, a memory module, or a hybrid of a storage device and memory module. Examples of a storage device include an SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

For example, the electronic device 106 can be a volatile or non-volatile memory device. In some embodiments, the electronic device 106 can be a DRAM array, SRAM array, STT RAM array, PCRAM array, TRAM array, RRAM array, NAND flash array, and/or NOR flash array, for instance. The arrays 130 can comprise memory cells arranged in rows coupled by access lines (which may be referred to herein as word lines or select lines) and columns coupled by sense lines (which may be referred to herein as digit lines or data lines).

As shown in FIG. 1, the controller 104 can include a voltage regulation component 113 (e.g., a voltage regulator and/or converter). Although it is illustrated that the controller 104 includes a single regulator 113, the controller 104 can include a plurality of regulators. The regulators can include a low-dropout (LDO) regulator, a buck-boost converter, a buck regulator, a boost regulator, or combination thereof, although embodiments are not so limited.

As shown in FIG. 1, the voltage regulator 113 can be implemented with one or more loop systems (“loop” shown in FIG. 1), such as loop systems 112-1, . . . , 112-N (collectively referred to as loop systems 112). At least one of the loop systems 112 can sample and hence stabilize one or more reference voltages (e.g., ramp voltages), while another one of the loop systems 112 can detect “reverse current” or “negative current” through an inductor (e.g., the inductor 226 shown in FIG. 2) of the voltage regulator 113, which may indicate that the voltage regulator 113 is in a DCM (as opposed to being in a CCM). Further details of the voltage regulator 113 are described in connection with FIG. 2.

FIG. 2 illustrates a switching voltage regulator 213 having a compensation circuit 230 in accordance with some embodiments of the present disclosure. Although embodiments are not so limited, the switching voltage regulator 213 may include step-up, step-down, or buck-boost DC-DC converters and,

The regulator 213 includes two drivers 222-1 (“HIGH SIDE DRIVER”), 222-2 (“LOW SIDE DRIVER”) that are respectively coupled to and configured to control switching elements (alternatively referred to as “switches”) 224-1 (“HS” shown in FIG. 2), 224-2 (“LS” shown in FIG. 2). Although embodiments are not so limited, the transistors 224-1, 224-2 can be metal-oxide-semiconductor field-effect (MOFSET) transistors. The “HIGH SIDE” driver 222-1 is configured to control the transistor 224-1 that is placed between the (e.g., positive) power supply (“VIN” shown in FIG. 2 and alternatively referred to as “power source”) and an input of inductor 226, while the “LOW SIDE” driver 222-2 is configured to control the transistor 224-2 that is placed between the (e.g., positive) input of the inductor 226 and ground (GND). For example, the driver 222-1 can generate and apply a control signal to switch on the high-side transistor 224-1, allowing current to flow from the positive power supply (“VIN” shown in FIG. 2) through the inductor 226 to “VOUT” shown in FIG. 2. For example, the driver 222-2 can generate and apply a control signal to switch the low-side transistor 224-2 on, allowing current to flow from the inductor and then to ground via the transistor 224-2.

The driver logic 242 can control (e.g., activate or deactivate) the drivers 222-1 and 222-2 in conjunction with various circuitry configured to provide timing, determining when the low and/or high switches are to be activated or deactivated, thereby alternating between the on-cycle and off-cycle. As used herein, the term “on-cycle” refers to the period during which driver switch 224-1 is active (switched on), while the term “off-cycle” refers to the period during which switch 224-2 is active (switched on). The on-cycle and off-cycle alternate, defining a duty cycle (the percentage of the “on-cycle” within a particular period of time).

For example, the driver logic 242 can control the duration for which the high-side switch 224-1 remains on based on timing indication provided from the timer 236 (“ON TIMER” shown in FIG. 2), determining how much energy is delivered to the inductor 226 (configured to provide “VOUT” shown in FIG. 2 and alternatively referred to as an output inductor) and output load (receiving power from the regulator 213) during each switching cycle. For example, the driver logic 242 can operate to ensure that the low-side switch 224-2 remains on (after the high-side switch turns off) for a minimum specified time based on timing indication provided from the timer 238 (“MIN OFF TIMER” shown in FIG. 2), preventing excessive switching and ensuring stability in the operation of the regulator. In sum, the inductor current may ramp up when the “HIGH-SIDE” switch 224-1 is on and ramps down when the “LOW-SIDE” is on.

As shown in FIG. 2, a signal “PON” is an activation signal that causes the driver 222-1 to activate the switch 224-1 and a signal “NON” is another activation signal that causes the driver 222-2 to activate the switch 224-2. The driver logic 242 can manage additional control functions, such as fault protection (overcurrent, thermal shutdown, overvoltage protection), mode transitions, and synchronization with other parts of the system, ensuring safe, efficient, and reliable operation of the regulator, based on timing indication provided from the miscellaneous logic 240 (“MISC LOGIC” shown in FIG. 2).

As used herein, a state, phase, cycle, etc., in which the switch 224-1 is activated in response to the “PON” signal is referred to as a PON state, PON phase, PON cycle, etc., respectively. Further, as used herein, a state, phase, cycle, etc., in which the switch 224-2 is activated in response to the “NON” signal is referred to as a NON state, NON phase, NON cycle, etc., respectively.

The regulator 213 further includes a protection circuit 244 coupled to the miscellaneous logic 240. The protection circuit can be configured to monitor the system for issues such as overvoltage, undervoltage, overcurrent, overheating, etc., such as reverse voltage indication (RVI) circuit, input over-voltage protection (OVP) circuit, etc. When a fault is detected, the protection circuit 244 can signal the miscellaneous logic 240 to take corrective actions, such as adjusting the power output, disabling the system, or reducing power to protect the components. These circuits ensure the system operates safely and reliably under both normal and fault conditions.

As shown in FIG. 2, the regulator 213 also includes an inductor 226, which is located in the common node of the switches 224-1, 224-2. The inductor 226 is further coupled to the capacitor 229. The inductor 226 and conductor 229 act as an energy storage element. When the high-side MOSFET 224-1 is on (e.g., during the PON state), current flows from the supply through the inductor 226 to the load (e.g., a circuit, component, device, etc. external to the regulator 213). During this phase, the inductor 226 can store energy as well. When the low-side MOSFET 224-2 is on (e.g., during the NON state) the inductor 226 can continue supplying current to the load (e.g., a circuit, component, device external to the regulator 213 that the regulator 213 provides a regulated voltage) as it discharges its stored energy. In some embodiments, the switches 224-1 and 224-2 can be alternately turned on (activated or put into an activated stated) and off (deactivated or put into a deactivated state) as the “PON” and “NON” signals are alternately provided to the drivers 222-1 and 222-2, respectively, to activate switches 224-1 and 224-2.

The regulator 213 can switch between a DCM and a CCM depending on inductor current, load demand, inductor energy storage, etc. In one example, when the current in the inductor 226 falls to zero (or becomes negative), the regulator 213 switches from a CCM to a DCM. In another example, if the load current decreases to light load condition, the output voltage (“VOUT” shown in FIG. 2) will discharge slowly (e.g., gradually). To maintain the voltage regulation, the inductor current would need to become negative, which would make the system inefficient. To prevent this, an RVI circuit (e.g., the RVI circuit 232) is implemented to ensure that the current is not allowed to go negative, which allows the output voltage to discharge slowly (e.g., gradually) with the load current. When the inductor current reaches zero, it results in a switch from a CCM to a DCM. Conversely, if the load increases to heavy load condition, the inductor current may not reach zero, keeping the regulator in a CCM or switches to a CCM from a DCM. In a different example, the amount of energy stored in the inductor 226 can determine how long it can maintain current flow. When that energy is depleted, the inductor current may decay to zero, causing a switch from a CCM to a DCM.

As shown in FIG. 2, the regulator 213 also includes loop systems, such as a loop system 230 coupled to an input node of the inductor 226 and a loop system 228 coupled to an output node of the inductor 226. The loop systems 228 and 230 can be closed loop systems. As used herein, the term “closed loop system” refers to a control system that continuously monitors its output and compares it to the desired value, using negative feedback to adjust the input and minimize deviations.

Each loop system 228 and 230 can be or include one or more filters. As used herein, the term “filter” refers to an electronic circuit that allows certain frequencies or types of signals to pass through while attenuating or blocking others. The filter may be a low-pass filter (passing low frequencies and attenuates high frequencies), high-pass filter (passing high frequencies and attenuates low frequencies), or band-pass filter (BPF, passing a certain range of frequencies and attenuates frequencies outside this range), among others.

As shown in FIG. 2, the loop system 228 can be a multi-stage loop system, which includes an error amplifier 228-1, a transconductance stage 228-2, and a resistor-capacitor (RC) network for compensation of the error amplifier loop consisting of 228-1, 228-2. The RC network of the loop system 228 includes a capacitor (“CE” shown in FIG. 2) located between the output of the error amplifier 228-1 and the inverting input of the error amplifier 228-1. The RC network of the loop system 228 also includes a resistor (“RE” shown in FIG. 2) located between the inverting input of the error amplifier 228-1 and the output of the inductor 226. The RC network can be a compensation network, which stabilizes the feedback loop by shaping the frequency response of the system, preventing oscillations and ensuring stability.

The resistor “RE” functions as a voltage to current converter, taking the output voltage (“VOUT”) of the inductor and feeds it to the loop system 228 such that the error amplifier 228-1 compares that to the reference voltage (“VREF” shown in FIG. 2). The capacitor “CE” integrates the current through “RE”, influencing the phase margin of the loop system 228. The integration feature of “CE” and “RE” combination makes the loop system 228 to respond slowly due to variation in “VOUT” caused by load current transients.

The capacitor “CE” can control the high-frequency behavior of the feedback loop, filtering out high-frequency noise or oscillations, and influencing the phase margin of the loop system 228. The resistor “RE” can function as a feedback resistor, taking a portion of the output voltage (“VOUT”) of the inductor and feeds it to the loop system 228 such that the error amplifier 228-1 compares that to the reference voltage (“VREF” shown in FIG. 2 and alternatively referred to as the “reference output voltage”). The reference voltage “VREF” provides a target level that the regulator 213 is designed to keep the output voltage close to, even in the presence of changes in load or input voltage. The transconductance stage 228-2 can function as an error amplifier, which generates an output signal based on comparison between input signals (feedback and reference). For example, the error amplifier 228-1 can generate an analog signal as an output signal based on the difference between the two input signals. The error amplifier 228-1 outputs an output voltage (“VEA” shown in FIG. 2), which can be an error signal. The output voltage “VEA” can correspond to the difference between the two input voltages of the error amplifier 228-1.

The output voltage from the error amplifier 228-1 then can be input to the transconductance stage 228-2 as an inverting input, while an output voltage (“VOUT” shown in FIG. 2) of the inductor 226 can be input to the transconductance stage 228-2 as a non-inverting input. Accordingly, an output of the transconductance stage 228-2 corresponds to the difference between the two input voltages (“VOUT” and “VEA”) of the transconductance stage 228-2.

The loop system 228 can operate to adjust the duty cycle of the converter's switches, thereby controlling “VOUT” to bring it closer to the target value defined by “VREF”. For example, when there is a change in “VOUT” (due to load transients, input voltage changes, or switching mode transitions), the error amplifier can detect the deviation from “VREF” and generates a corresponding adjustment signal. Accordingly, the settling time of the output voltage “VOUT” (e.g., how quickly it reaches its steady-state value after transitions, changes, etc.) can be influenced by how fast the error amplifier can respond to changes in the feedback loop.

The loop system 230 is coupled to an input node of the inductor 226 with a reverse voltage indicator (RVI) circuit 232 (that is also coupled to the input node of the inductor 226). More particularly, the RVI circuit 232 includes a comparator 232-1 coupled to an input node of the inductor 226 and configured to compare a voltage at the input node (received at a non-inverting input of the comparator 232-1) to the ground voltage (0V) (received at an inverting input of the comparator 232-1).

The comparator 232-1 can detect negative current through the transistor 224-2 and/or the inductor 226 (alternatively referred to as “reverse current” through the inductor 226). Once the negative current is detected, a signal indicative of such negative current is provided from the comparator 232-1 to a set input (“S” as shown in FIG. 2) of the flip-flop 232-2 (e.g., the RS flip-flop 232-2). The flip-flop 232 can prioritize Reset over Set. Such Flip-flops can be realized in multiple ways.

Negative current can occur when the stored energy in the inductor 226 is depleted during the off-phase of the switching cycle and/or when the load demand is low or non-existent, causing the regulator 213 to operate in a DCM. In this mode, the capacitor 229 can provide current to the load instead of the inductor 226.

When a signal indicative of negative current through the transistor 224-2 is received and applied to the set input of the flip-flop 232-2, this sets the flip-flop 232-2, causing the output “Q” to go high, which corresponds to an “RVI” signal provided to the protection circuit 244. In response to the “RVI” signal, the protection circuit 244 disables both the high-side and low-side drivers 222-1, 222-2, resulting in the switches 224-1, 224-2 to be turned off, allowing the regulator 213 to operate in a DCM. Alternatively, when a “PON” signal is received and applied to a reset input (“R” as shown in FIG. 2), this resets the flip-flop, driving the “Q” output (and hence “PON”) low. Therefore, the PON and RVI signals may not be high at the same time. The PON signal can be received (from the driver 222-1) when it is desired that the capacitor 229 is required to be recharged.

The loop system 230 includes logic gates 230-1, 230-2 that are respectively coupled to switches 230-3, 230-4. Although embodiments are not so limited, the switches 230-3, 230-4 can each be a transistor switch, a mechanical switch, etc.

Further, although embodiments are not so limited, the logic gates 230-1 and 230-2 can each be an OR gate. For example, the OR gate 230-1 receives two input signals, such as the “NON” and “RVI” signals as shown in FIG. 2. The “NON” signal received at the OR gate 230-1 can be analogous to an activation signal provided by the driver logic 242 to the driver 222-2 to cause the driver 222-2 to activate the switch 224-2. Meanwhile, the “RVI” signal received at the OR gate 230-1 can be analogous to the signal provided by the RVI circuit 232, which indicates negative current through the switch 224-2 and/or the inductor 226. If either the “NON” or “RVI” signal is high, or both are high, the OR gate 230-1 outputs a high signal, which can cause switch 230-3 to activate (e.g., to close, allowing current to flow through switch 230-3 and the capacitor 230-7 to be charged). Otherwise, if both “NON” and “RVI” input signals are low, the OR gate 230-1 can output a low signal, which can prevent the switch 230-3 from being activated.

Similarly, an OR gate 230-2 receives two input signals, such as the “PON” and “RVI” signals, as shown in FIG. 2. The “PON” signal received at the OR gate 230-2 can be analogous to an activation signal provided by the driver logic 242 to the driver 222-1 to activate the switch 224-1. Meanwhile, the “RVI” signal received at the OR gate 230-2 can be analogous to the signal provided by the RVI circuit 232, which indicates negative current through the switch 224-2 and/or the inductor 226. If either the “PON” or “RVI” signal is high, or both are high, the OR gate 230-2 outputs a high signal, which can cause switch 230-4 to activate (e.g., to close, allowing current to flow through switch 230-4). Otherwise, if both “PON” and “RVI” input signals are low, the OR gate 230-2 can output a low signal, which can prevent switch 230-4 from being activated Hence, the capacitor 230-8 retains its charge.

Each switch 230-3 and 230-4 is further coupled to a capacitor 230-7, 230-8 and a buffer 230-5, 230-6 respectively. Alternatively speaking, the capacitor 230-7 and the buffer 230-5 (e.g., a unity gain buffer) are coupled to the a “RAMP_P” signal through the switch 230-3, and the capacitor 230-8 and the buffer 230-6 (e.g., a unity gain buffer) are coupled to the output of buffer 230-5 through the switch 230-4. Although embodiments are not so limited, the capacitors 230-7 and 230-8 can each have a capacitance of 1 picofarad (1 pF). Each capacitor can function as a hold capacitor that can be used for various samplings, such as a valley sampling among others. More particularly, once switch 230-3 is activated (or in a closed position), the positive ramp voltage (“RAMP_P” shown in FIG. 2) is captured (e.g., sampled) and the sampled voltage “VSAMPLED” can be stored in the capacitor 230-7. Similarly, once switch 230-4 is activated (or in a closed position), the sampled voltage “VSAMPLED” is captured (sampled) and the sampled voltage (“VHOLD” shown in FIG. 2 and alternatively referred to as “held voltage”) stored in the capacitor 230-8.

The buffer 230-5 receives the sampled voltage “VSAMPLED” at its non-inverting input. Accordingly, an output of the buffer 230-5 is referred to as a buffered version of the sampled voltage “VSAMPLED”. Also, the operational amplifier 230-6 receives the held ramp voltage “VHOLD” at its non-inverting input. Accordingly, an output of the buffer 230-6 is referred to as a buffered version of the held ramp voltage “VHOLD”. Further, as shown in FIG. 2, the outputs of the operational amplifiers 230-5 and 230-6 are coupled to their respective inverting inputs, creating a negative feedback, in which the outputs of the operational amplifiers 230-5 and 230-6 are fed back to their inverting inputs. These operational amplifiers 230-5 and 230-6 are designed to act as unity gain buffers. These unity gain buffers are used so that sample and hold operations on the “RAMP_P” signal does not load the “RAMP_P” signal.

The loop system 230 tracks and emulates the inductor current using the positive ramp voltage, “RAMP_P”, and the negative ramp voltage, “RAMP_N”. “RAMP_P” represents a synthesized signal that mimics the behavior of the inductor current, which is proportional to the voltage difference across the inductor 226. The loop system 230 can also function as a valley sampling network. For example, as compared to those approaches, in which positive ramp voltage (“RAMP_P” shown in FIG. 2) is directly passed into the filter (e.g., low-pass filter), the “RAMP_P” is sampled and can be used to generate base of the ramp voltage (“RAMP_N” shown in FIG. 2) prior to being passed through the “R2”, “C2”, and the transconductance stage 235. This ensures that the difference between “RAMP_P” and “RAMP_N” (RAMP_P RAMP_N″), which is fed to the comparator 234, maintains the same peak-to-peak value (“RAMP_Pp-p”), over the transitions (e.g., from a CCM to a DCM, or vice versa) and regardless of load conditions and whether the circuit is in CCM or DCM and irrespective of load currents.

In the CCM, the switches 224-1 and 224-2 can be alternately turned on (activated or put into an activated stated) and off (deactivated or put into a deactivated state) as the “PON” and “NON” signals are alternately provided to the drivers 222-1 and 222-2, respectively, to activate switches 224-1 and 224-2. When the PON state is transitioned to the NON state (e.g., while the “NON” signal is high), OR gate 230-1 can activate switch 230-3, causing the voltage “RAMP_P” to be sampled (e.g., captured by the capacitor 230-7). Alternatively, When the NON state is transitioned to the PON state (e.g., while the “PON” signal is high), OR gate 230-2 can activate switch 230-4, causing the held voltage “VHOLD” to be sampled (e.g., captured by the capacitor 230-8).

In the DCM, the switches 224-1 and 224-2 may both be generally off (deactivated) as the inductor current drops to or below zero, triggering generation of the “RVI” signal from the RVI circuit 232 as described herein. With the inductor current at zero, the voltage at the intermediate node (“SWOUT” shown in FIG. 2) corresponds to “VOUT.” Consequently, the voltages “RAMP_P” and “RAMP_N” also correspond to “VOUT”, which ensures that the valley sampling process remains stable even in DCM.

During DCM, when the “PON” and “NON” signals are occasionally provided to the drivers 222-1 and 222-2, respectively and alternately, to activate switches 224-1 and 224-2, valley sampling can be performed in a similar manner as during CCM. For example, when the PON state transitions to the NON state (e.g., while the “NON” signal is high), OR gate 230-1 can activate switch 230-3, causing the voltage “RAMP_P” to be sampled (e.g., captured by the capacitor 230-7). Alternatively, when the NON state transitions to the RVI state (e.g., while the “RVI” signal is high), OR gates 230-2 and 230-1 can activate switches 230-3 and 230-4. This causes both “RAMP_P” and “RAMP_N” signals to correspond to “VOUT”, which is also the state of “SWOUT” during DCM.

The valley sampling process of embodiments of the present disclosure as described herein provides a more stable reference signal during both Continuous Conduction Mode (CCM) and Discontinuous Conduction Mode (DCM), which reduces the dependency of the error amplifier's output on load variations and mode transitions. For example, without valley sampling, changes in load (particular during mode transitions between CCM and DCM) would have directly affected the RAMP_P-RAMP_N, which then places a demand on the error amplifier 228-1 to continually adjust to these variations. By keeping RAMP_P-RAMP N constant, the valley sampling network provides a steady reference signal, thereby shielding the error amplifier from variations due to load or mode transitions. This “decoupling” allows the error amplifier 228-1 to regulate “VOUT” based solely on deviations from “VREF”. As a result, the error amplifier 228-1 responds faster and more efficiently, improving the speed of the output voltage regulation.

The loop system 230 includes a transconductance stage 235 coupled to an RC network, which can include two “branches” with a first branch including a resistor “R1” and a capacitor “C1”, and a second branch including a resistor “R2” and a capacitor “C2” with the valley sampling circuit 230 located between the two branches. As shown in FIG. 2, the first branch is coupled to ground (through “C1”), a non-inverting input of the transconductance stage 235 (with “R1” and “C1” in parallel to the non-inverting input), and the second branch including “R2”, “C2”. Further, as shown in FIG. 2, the second branch is coupled to ground (through “C2”), an inverting input of the transconductance stage 235, and the first branch including “R1”, C1″. The transconductance stage 235 (along with at least a portion of the RC network, such as “R2” and “C2”) can be a filter, such as a low-pass filter (LPF), which passes low frequencies and attenuates high frequencies.

In essence, the output signal

$${V}_{OUT} + \frac{{g}_{m 2}}{{g}_{m 1}} \times ( {V}_{Rampp} - {V}_{Rampn} )$$

is compared against “VEA”. Since “VEA” is a slow moving signal, it is desired that the filters 230 do not affect the DC regulation of the loop.

The outputs of the filters 228, 230 then can be input to an inverting input of the comparator 234. For example, a voltage received at the inverting input of the comparator corresponds to a sum of the output currents of the filters 228, 230 (e.g., gₘ₁×(Vₒᵤₜ−V_{EA})+gₘ₂×(V_{Rampp}−V_{Rampn})) multiplied by “R3”. The combination of these voltages received at the inverting input of the comparator 234 then can be compared against a common mode voltage 237 received at a non-inverting input of the comparator 234. As used herein, the term “common mode voltage” refers to the average voltage on the input(s) of the comparator 234. The common mode voltage may be any voltage such that the comparator operates in the linear region. The result of the comparison can be provided from the comparator 234 to the “control loop” (which can include timers 236, 238, 240, and/or a driver logic 242), which then can adjust the duty cycle of the power switches (e.g., switches 224-1, 224-2) to maintain optimal operation and respond appropriately to load transients based on the result of the comparison provided from the comparator 234.

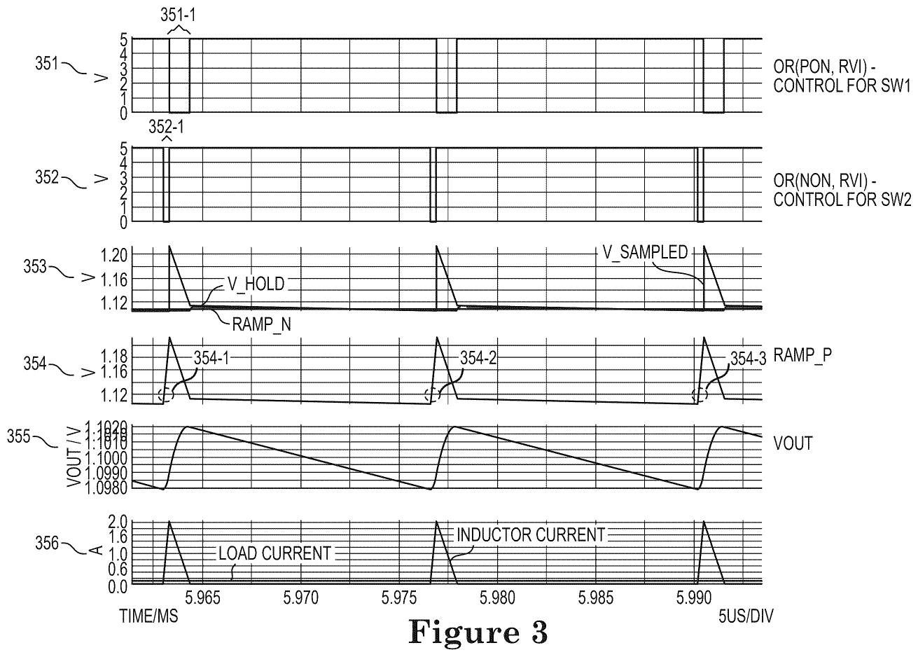

FIG. 3 illustrates graphs 351, 352, 353, 354, 355, and 356 showing states of various signals during a discontinuous conduction mode (DCM) in accordance with some embodiments of the present disclosure. Graph 351 shows the control signal (e.g., the output of the OR gate 230-2 shown in FIG. 2) for the switch 230-4 shown in FIG. 2. For example, the transitions between high and low states in graph 351 indicate when the switch 230-4 is turned on (high state) or off (low state). More particularly, when either “PON” or “RVI” signal shown in FIG. 2 is high, the OR gate 230-2 outputs a high signal, which would cause the switch to close and conduct. Similarly, graph 352 shows the control signal (e.g., the output of the OR gate 230-1 shown in FIG. 2) for the switch 230-3 shown in FIG. 2. For example, the transitions between high and low states in this graph show when switch 230-3 is turned on or off, respectively. More particularly, when either “NON” or “RVI” signal shown in FIG. 2 is high, the OR gate 230-1 outputs a high signal, and the switch closes, allowing current flow.

Furthermore, graph 353 shows the states of “VSAMPLED” (corresponding to “VSAMPLED” shown in FIG. 2), “VHOLD” (corresponding to “VHOLD” shown in FIG. 2), and “RAMP_N” (corresponding to “RAMP_N” shown in FIG. 2) signals. Graph 354 shows the states of “RAMP_P” signal (corresponding to “RAMP_P” shown in FIG. 2). Graph 355 shows the nature of “VOUT” signal, which corresponds to an output voltage of the regulator 213 (that is maintained to be stable even as the load changes or the system switches between CCM and DCM). Graph 356 shows the inductor current (e.g., the current flowing through the inductor 226) and the load current (e.g., the current flowing from the output of the converter into the load).

While the regulator (e.g., regulator 213) is in DCM, both the high-side and low-side switches (e.g., switches 224-1 and 224-2 shown in FIG. 2) may be generally off (in a deactivated state) due to the RVI signal (e.g., generated and output by the RVI circuit 232) being high, which indicates a reverse current through the inductor 226. When the output voltage decreases below “VEA” (“VEA” corresponding to the output of the error amplifier 228-1 shown in FIG. 2), such as before the period 352-1 shown in FIG. 3, the driver logic 242 may activate the high-side switch 224-1 (e.g., over period 352-1, which corresponds to a PON state) to ramp up the inductor current. This resets the RVI signal and causes the ramp voltage “RAMP_P” to increase. Once the timer (e.g., the timer 236 shown in FIG. 2) expires, the driver logic 242 may deactivate the high-side switch 224-1 and activate the low-side switch 224-2 (e.g., over period 351-1, which corresponds to a NON state), while the RVI signal remains low. Therefore, the transition from the NON state to the RVI state (from transition from the period 351-1 to the RVI period) may indicate the valley of the “RAMP_P” as shown in FIG. 3. When the inductor current becomes negative (causing the RVI signal to go high), both the high-side and low-side switches 224-1 and 224-2 can be deactivated (e.g., subsequent to the period 351-1, for example) until the output voltage decreases below the threshold.

As shown by graph 354, valley sampling is performed by sampling “VSAMPLED” at the valley of “RAMP_P” (e.g., respectively shown by 354-1, 354-2, 354-2 of FIG. 3) when the NON state and/or cycle is entered. More particularly, each sampled “VSAMPLED” can be captured and stored in the capacitor 230-7 when the switch 230-3 is activated and put into a closed position (in response to either the “NON” or “RVI” signal input to the OR gate 230-1 is high). Further, “VHOLD” as illustrated in graph 353 represents sampled voltage (e.g., “VSAMPLED”) being sampled when the PON state is entered.

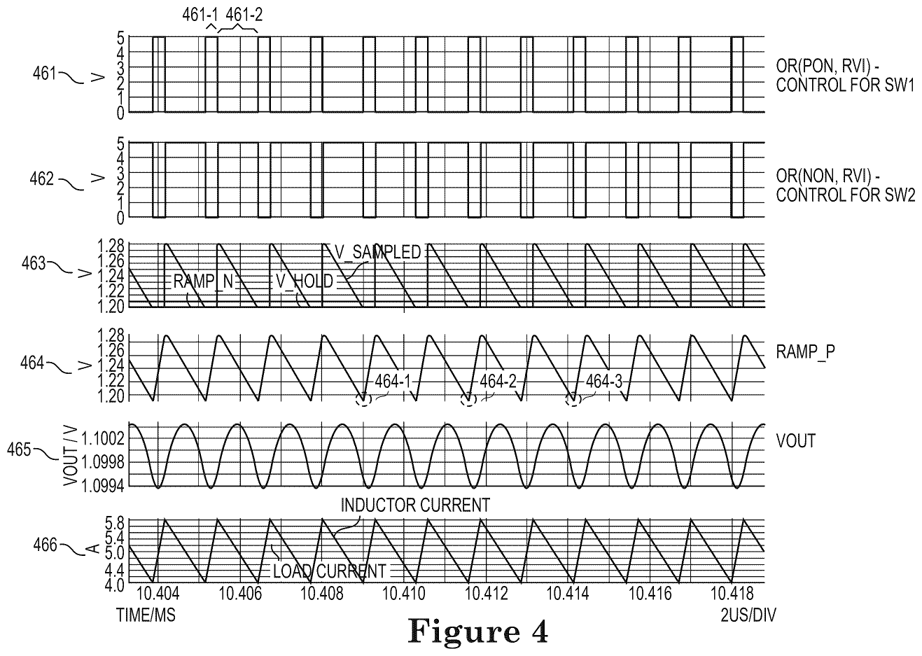

FIG. 4 illustrates graphs 461, 462, 463, 464, 465, and 466 showing states of various signals during a continuous conduction mode (CCM) in accordance with some embodiments of the present disclosure. Signals shown in graphs 461, 462, 463, 464, 465, and 466 are respectively analogous to the signals respectively shown in graphs 351, 352, 353, 354, 355, and 356 of FIG. 3. For example, the signals shown in graphs 461, 462, 463, 464, 465, and 466 correspond to the control signals for switch 230-4, switch 230-3, the “VSAMPLED” signal, the “VHOLD” signal, the “RAMP_N” signal, the “RAMP_P” signal, the “VOUT” signal, the inductor current, and the load current, as also illustrated in graphs 351, 352, 353, 354, 355, and 356 of FIG. 3, respectively.

As shown by graphs 461 and 462, PON and NON cycles are alternatively on and off. For example, the PON cycle may be on (e.g., in an activated state) during period 461-1, while the NON cycle is off (e.g., in a deactivated state). Further, the PON cycle may be off (e.g., in a deactivated state) during period 461-2, while the NON cycle is on (e.g., in an activated state).

Similar to graph 354 and as also shown by graph 463, valley sampling is performed by sampling “VSAMPLED” at the valley of “RAMP_P” (such as at 464-1, 464-2, and 464-3 among others) during the NON state and/or cycle (when the low-side switch 222-2 shown in FIG. 2 is on). More particularly, each sampled “VSAMPLED” can be captured and stored in the capacitor 230-7 when the switch 230-3 is activated and put into a closed position (in response to either the “NON” or “RVI” signal input to the OR gate 230-1 is high). Further, “VHOLD” as illustrated in graph 353 represents sampled voltage (e.g., “VSAMPLED”) being held (e.g., at the capacitor “C2” shown in FIG. 2) during the NON state in response to the “NON” signal shown in FIG. 2 (e.g., when the low-side switch 224-2 and/or the switch 230-4 shown in FIG. 2 is off in response to the “PON” and “NON” signals).

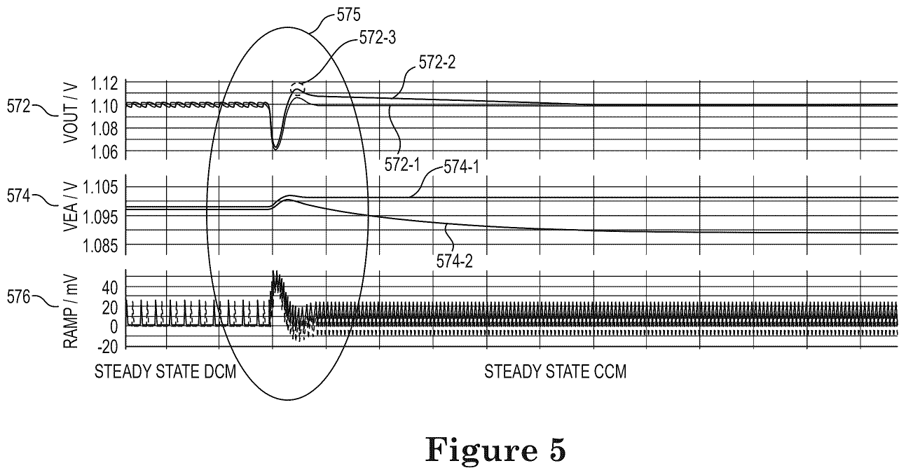

FIG. 5 illustrates graphs 572, 574, and 576 showing states of various signals during transition (indicated by 575 shown in FIG. 5) from a DCM to a CCM in accordance with some embodiments of the present disclosure. The graphs 572 and 574 shows the response of the output voltage (“VOUT” shown in FIG. 2) of the regulator 113, 213 and the output of the error amplifier 228-1 (“VEA” shown in FIG. 2), respectively, during the transition from a DCM to a CCM. For example, the line 572-1 shows the response of the output voltage of a regulator 113, 213 with the compensation circuit 230 and/or the RVI circuit 232, while the line 572-2 shows the response of the output voltage of a regulator that may not be implemented with the compensation circuit 230 and/or the RVI circuit 232 in the same or similar manner as the regulator 113, 213. Similarly, the line 574-1 shows the response of the output of the error amplifier 228-1 of the regulator 113, 213 with the compensation circuit 230 and/or the RVI circuit 232, while the line 574-2 shows the response of the output of the error amplifier 228-1 of a regulator that may not be implemented with the compensation circuit 230 and/or the RVI circuit 232 in the same or similar manner as the regulator 113, 213.

As indicated by the line 572-1, the regulator 113, 213 transitions from a DCM to a CCM without introducing the voltage overshoot (indicated by 572-3 shown in FIG. 5) and/or slow recovery time (alternatively referred to as settling time) as presented in the line 572-2. For example, the line 572-1 recovered and settled faster to approximately 1.10V compared to the line 572-2. Similarly, the output of the error amplifier, shown by line 574-1 during transition 575, does not change as drastically as the output of the error amplifier shown by line 574-2.

Graph 576 shows the difference between the voltage values of “RAMP_P” and “RAMP_N” shown in FIG. 2. For example, the solid line represents the behavior of the voltage difference between “RAMP_P” and “RAMP_N” in regulators 113 and 213, while the dotted line represents the behavior of the voltage difference between “RAMP_P” and “RAMP_N” in a regulator that may not implement the compensation circuit 230 and/or the RVI circuit 232 in the same or similar manner as regulators 113 and 213. Graph 576 highlights the differences in the ramp signal behavior between the two methods. As shown by the solid line of graph 576, embodiments of the present disclosure may offer more stable or precise control of the signal, as compared to some other approaches (illustrated by the dotted line). Further, it is noted that the base of the difference between “RAMP_P” and “RAMP_N” behaves irrespectively of the load, causing this to not change drastically.

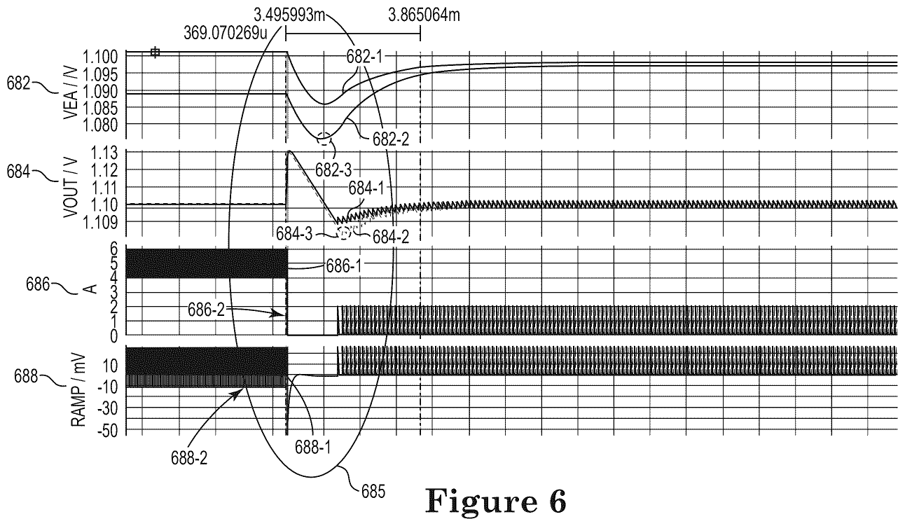

FIG. 6 illustrates a graphs showing states of various signals during transition 685 from a CCM to a DCM in accordance with some embodiments of the present disclosure. Graphs 682 and 684 show the response of the output of the error amplifier 228-1 (“VEA” shown in FIG. 2) and the output voltage (“VOUT” shown in FIG. 2) of the regulator 113, 213, respectively, during the transition from a CCM to a DCM. For example, the line 682-1 shows the response of the output of the error amplifier 228-1 of the regulator 113, 213 with the compensation circuit 230 and/or the RVI circuit 232, while the line 682-2 shows the response of the output of the error amplifier 228-1 of a regulator that may not be implemented with the compensation circuit 230 and/or the RVI circuit 232 in the same or similar manner as the regulator 113, 213. Similarly, the line 684-1 shows the response of the output voltage of a regulator 113, 213 with the compensation circuit 230 and/or the RVI circuit 232, while the line 684-2 shows the response of the output voltage of a regulator that may not be implemented with the compensation circuit 230 and/or the RVI circuit 232 in the same or similar manner as the regulator 113, 213.

The transition from CCM to DCM, as shown by line 684-2, introduces voltage undershoot (indicated by marker 684-3 in FIG. 6) and/or a slower recovery time (also referred to as settling time). However, line 684-1 shows a faster recovery, settling at approximately 1.10V compared to line 684-2.

The signal shown by line 686-1 of graph 686 represents the inductor current (e.g., the current flowing through inductor 226 in FIG. 2), while line 686-2 of graph 686 represents the load current (e.g., the current being provided to the load). Further, graph 688 shows the difference between the voltage values of “RAMP_P” and “RAMP_N” shown in FIG. 2. For example, the solid line represents the behavior of the voltage difference between “RAMP_P” and “RAMP_N” in regulators 113 and 213, while the dotted line represents the behavior of the voltage difference between “RAMP_P” and “RAMP_N” in a regulator that may not implement the compensation circuit 230 and/or the RVI circuit 232 in the same or similar manner as regulators 113 and 213. As shown by the solid line 688-1, embodiments of the present disclosure may offer more stable or precise control of the signal, as indicated by a smoother and more tightly controlled waveform compared to some other approaches (illustrated by the dotted line). it is noted that the base of the difference between “RAMP_P” and “RAMP_N” behaves irrespectively of the load, causing this to not change drastically.

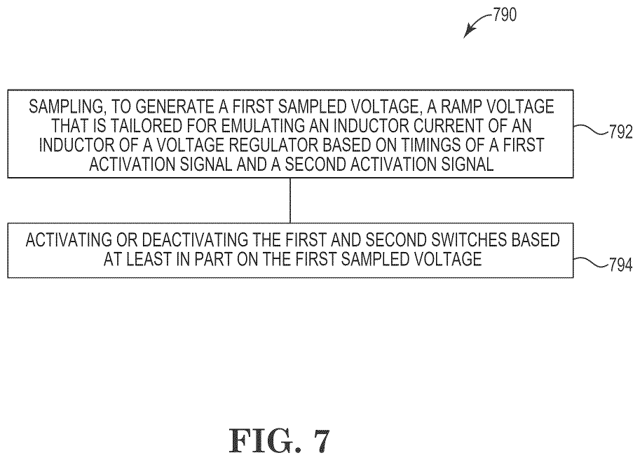

FIG. 7 is a flow diagram corresponding to a method for operating a voltage regulator having a band-pass filter in accordance with some embodiments of the present disclosure. The method 790 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 790 is performed by the voltage regulator 113, 213 of FIGS. 1 and 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 792, a ramp voltage tailored for emulating an inductor current of an inductor (e.g., the inductor 226 shown in FIG. 2) of a voltage regulator (e.g., the voltage regulator 113, 213 shown in FIGS. 1 and 2, respectively) can be sampled (to generate a first sampled voltage “VSAMPLED”) based on timings of a first activation signal (e.g., “PON” signal generated by the driver logic 242 and shown in FIG. 2) and a second activation signal (e.g., “NON” signal generated by the driver logic 242 and shown in FIG. 2). The first activation signal “PON”, when driven high, activates a first switch (e.g., the switches 224-1 shown in FIG. 2) of the voltage regulator 113, 213 that is coupled to a power source (e.g., “VIN” shown in FIG. 2). The second activation signal “NON”, when driven high, activates a second switch (e.g., the switches 224-2 shown in FIG. 2) of the voltage regulator 113, 213 that is coupled to ground. At 794, the first and second switches 224-1, 224-2 of the voltage regulator 113, 213 can be activated or deactivated based at least in part on the first sampled voltage “VSAMPLED”.

In some embodiments, the ramp voltage “RAMP_P” can be sampled responsive to the second activation signal “NON” being driven high. The first sampled voltage “VSAMPLED” is stored on the capacitor 230-7. An output of the first buffer 230-5 (which corresponds to the first sampled voltage “VSAMPLED”) can be sampled (to generate a second sampled voltage “VHOLD”) responsive to the first activation signal “PON” being driven high. The second sampled voltage can be filtered via a filter (e.g., a low-pass filter including the transconductance stage 235, “R2”, and “C2”), which generates a filtered signal. The first and second switches 224-1, 224-2 of the voltage regulator 113, 213 can be activated or deactivated based at least in part on the filtered signal (e.g., an output of the transconductance stage 235).

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A voltage regulator, comprising:
an inductor coupled to an intermediate node located between a first switch and a second switch respectively coupled to a power source and ground, wherein a voltage at an output node of the inductor corresponds to an output voltage of the voltage regulator; and
a first circuit coupled to an input node of the inductor, the first circuit configured to sample a ramp voltage tailored for emulating an inductor current based on respective timings of a first activation signal to activate the first switch and a second activation signal to activate the second switch.

2. The voltage regulator of claim 1, further comprising:
a second circuit coupled to the input node of the inductor, the second circuit configured to:
detect a reverse current through the inductor; and
generate a signal indicative of the reverse current, wherein the generated signal is provided at least to the first circuit.

3. The voltage regulator of claim 2, wherein the voltage regulator is further configured to deactivate the first switch or the second switch, or both, in response to the signal indicative of the reverse current being generated.

4. The voltage regulator of claim 3, wherein the second circuit is configured to prevent the signal indicative of the reverse current from being generated in response to the first activation signal provided to the second circuit.

5. The voltage regulator of claim 2, wherein the first circuit is configured to sample the ramp voltage to generate a first sampled voltage in response to the second activation signal provided to the first circuit.

6. The voltage regulator of claim 5, wherein the first circuit is configured to sample the sampled ramp voltage to generate a second sampled voltage in response to the first activation signal provided to the first circuit.

7. The voltage regulator of claim 6, further comprising buffers having feedback loops and respectively configured to receive the first and second sampled voltages to reduce loading of remaining circuits corresponding to a subsequent phase of the first circuit.

8. The voltage regulator of claim 1, further comprising a third circuit coupled to the output node of the inductor, the third circuit comprising an error amplifier configured to compare the output voltage to a reference voltage.

9. An apparatus, comprising:
driver logic configured to:
generate a first activation signal to cause a first switch coupled to a power source to be activated; and
generate a second activation signal to cause a second switch coupled to ground to be activated;
an inductor coupled to an intermediate node located between the first switch and the second switch, wherein a voltage at an output node of the inductor corresponds to an output voltage of a voltage regulator; and
a first circuit coupled to an input node of the inductor, the first circuit configured to sample a ramp voltage tailored for emulating an inductor current of the inductor based on respective timings of the first activation signal and the second activation signal.

10. The apparatus of claim 9, further comprising a second circuit coupled to the input node of the inductor, the second circuit configured to:
drive, in response to a reverse current through the inductor being detected, a third signal indicative of the reverse current high; and
drive, in response to the reverse current through the inductor not being detected or the first activation signal being generated by the driver logic, the third signal indicative of the reverse current low.

11. The apparatus of claim 10, wherein the first circuit further comprises:
a first switch; and
a first logic gate coupled to the first switch, the first logic gate configured to control the first switch based on the second activation signal and the third signal indicative of the reverse current driven by the second circuit.

12. The apparatus of claim 11, wherein:
the first logic gate is configured to activate the first switch in response to at least one of the second activation signal or the third signal being driven high; and
the first circuit is configured to sample the ramp voltage tailored for emulating an inductor current to generate a first sampled voltage in response to the first logic gate is activated.

13. The apparatus of claim 11, further comprising a first buffer having a feedback loop, the first buffer configured to receive the first sampled voltage to reduce loading of remaining circuits corresponding to a subsequent phase of the first circuit.

14. The apparatus of claim 13, wherein the first circuit further comprises:
a second switch; and
a second logic gate coupled to the first switch, the second logic gate configured to control the second switch based on the first activation signal and the third signal indicative of the reverse current driven by the second circuit.

15. The apparatus of claim 14, wherein:
the second logic gate is configured to activate the second switch in response to at least one of the first activation signal or the third signal being driven high; and
the first circuit is configured to sample a first output of the first buffer to generate a second sampled voltage in response to the second logic gate is activated, wherein the first output of the first buffer corresponds to a buffered version of the first sampled voltage stabilized by the first buffer.

16. The apparatus of claim 11, further comprising a second buffer having a feedback loop, the second buffer configured to receive the second sampled voltage to reduce loading of remaining circuits corresponding to a subsequent phase of the first circuit.

17. A method, comprising:
sampling, to generate a first sampled voltage, a ramp voltage that is tailored for emulating an inductor current of an inductor of a voltage regulator based on timings of:
a first activation signal that, when driven high, activates a first switch of the voltage regulator that is coupled to a power source; and
a second activation signal that, when driven high, activates a second switch of the voltage regulator that is coupled to ground; and
activating or deactivating the first and second switches based at least in part on the first sampled voltage.

18. The method of claim 17, wherein sampling the ramp voltage based on the timings of the first activation signal and the second activation signal further comprises:
sampling the ramp voltage responsive to the second activation signal being driven high.

19. The method of claim 17, further comprising:
buffering the first sampled voltage by a first buffer having a feedback loop; and
sampling, to generate a second sampled voltage, an output of the first buffer responsive to the first activation signal being driven high.

20. The method of claim 17, further comprising:
filtering the second sampled voltage via a filter to generate a filtered signal; and
activating or deactivating the first and second switches of the voltage regulator based at least in part on the filtered signal.
